(19) United States
(12) Patent Application Publication
(10) Pub. No.: US 2012/0100915 A1
(43) Pub. Date: Apr. 26, 2012

(54) SYSTEM AND METHOD FOR AD PLACEMENT IN VIDEO GAME CONTENT

(75) Inventors: Eyal Margalit, Reut (IL); Nir Hagshury, Tel Aviv (IL)

(73) Assignee: TICTACTI LTD., Tel Aviv (IL)

(21) Appl. No.: 13/380,529

(22) PCT Filed: Jun. 22, 2010
(86) PCT No.: PCT/IL10/00492

§ 371 Date: Dec. 23, 2011

Related U.S. Application Data
(60) Provisional application No. 61/220,234, filed on Jun. 25, 2009.

(51) Int. Cl. A63F 13/00

(52) U.S. Cl. 463/31

(57) ABSTRACT

The present invention provides an ad placement system for superimposing advertising content onto video games, comprising: a. networked game playing means having access to a video game; b. object identification means having access to visual output of a plurality of game playing iterations of said video game; c. means for obtaining real-time visual captions; d. object tracking means; e. means for superimposing a stream of remotely stored advertising content onto said objects, in networked connection with said game playing means; f. emulation means that superimposes an invisible, click, touch or event enabled emulation layer on top of said visual output from said video game;

### FIELD OF THE INVENTION

The present invention generally pertains to a system and method for ad placement in video game content.

### BACKGROUND OF THE INVENTION

Provision of so-called ‘free’ online content by means of the web, is increasingly funded by integrated advertising. Often this advertising is placed within the page of the content, in a window-within-window format. Another form of conventional web based adverts are pop-up windows that overlay a new window on top of the content page. Yet another form of conventional adverts overlay a floating advert, often semi-transparent, on top of the content page. Whether confronted by overlay pop-ups or by adverts that share the space of the content window, the user has no control over the location, size, audible volume or content of the adverts. Indeed, users are quite often antagonized by the unexpected and uncontrolled relay of adverts. This has a negative effect on the propensity of the users to further investigate and perhaps purchase the product being advertised, and may eventually also alienate them from the content website altogether. Moreover, conventional forms of integrated advertisement rely on differing versions of web technologies such as HTML and Flash, and on web-browser specific or website specific construction methods, in order to assure that they operate properly. This often results in improper presentation of adverts and content errors, serving to further distance users from both the content and the adverts. Finally, conventional adverts tap into the same computing resources that provide the content, thereby draining these resources and degrading the quality and speed of actual content provision.

The commercially available Google-DoubleClick™, Yahoo!-Right Media™, WPP Group-24/7 Real Media™ and Microsoft-aQuantive™ deals are all attempts to own the best technology and data-analysis tools for online ad targeting. By serving ads to people based on their online activities, behavioral targeting promises to reach a more engaged audience with fewer ad impressions.

Online video advertising holds great promise. The high engagement factor of video combined with the Internet's tracking and targeting capabilities, offers a valuable revenue stream for Web publishers and a highly accountable method for brand advertisers to sway the hearts and minds of target audiences.

Next year represents a mass-market benchmark, as more than 50% of the US population—155.2 million people—will watch video online. How this audience reacts to online video advertising will ultimately shape the future of the format.

Product placement, or embedded marketing, is a type of advertising, in which promotional advertisements placed by marketers using real commercial products and services in media, where the presence of a particular brand is the result of an economic exchange. When featuring a product is not part of an economic exchange, it is called a product plug. Product placement appears in plays, film, television series, music videos, video games and books. It became more common starting in the 1980s, but can be traced back as early as 1949. Product placement occurs with the inclusion of a brand's logo in shot, or a favorable mention or appearance of a product in shot. This is done without disclosure, and under the premise that it is a natural part of the work. Most major movie releases today contain product placements. The most common form is movie and television placements and more recently computer and video games. Recently, websites have experimented with in-site product placement as a revenue model.

In early media, e.g. radio in the 1930s and 1940s and early television in the 1950s, programs were often underwritten by companies. “Soap operas” are called such because they were initially underwritten by consumer packaged goods companies such as Procter & Gamble or Unilever. Sponsorship still exists today with programs being sponsored by major vendors such as Hallmark. Incorporation of products into the actual plot of a TV show is generally called “brand integration”. A recent example is HBO's Sex in the City, where the plot revolved around, among other things, Absolut Vodka, a campaign upon which one of the protagonists was working, and a billboard in Times Square, where a bottle prevented an image of the model from being pornographic. Knight Rider, a TV series featuring a talking Pontiac Trans Am, is another example of brand integration.

Actual product placement, according to ERMA.org, a Hollywood product placement association falls into two categories: products or locations that are obtained from manufacturers or owners to reduce the cost of production, and products deliberately placed into productions in exchange for fees.

A very early example of product placement in film occurs in the 1946 film It's a Wonderful Life by Frank Capra where a young boy with aspirations to be an explorer displays a prominent copy of National Geographic. Another is in the 1949 film Love Happy, in which Harpo Marx cavorts on a rooftop among various billboards and at one point escapes from the villains on the old Mobil logo, the “Flying Red Horse”. In addition, the first film to win the Oscar for Best Picture, Wings (released in 1927), contained a plug for Hershey's. Another very early example potentially occurs in Jules Verne's Around the World in Eighty Days in which transport and shipping companies lobbied to be mentioned as it was initially published in serial form.

Still another example is the conspicuous display of Studebaker motor vehicles in the television show Mr. Ed, which was sponsored by the Studebaker Corporation from 1961 to 1963.

The earliest example of product placement in a computer or video game occurs in the 1984 game Action Biker for KP's Skips crisps.

The earliest example of product placement in a cartoon occurs in the Comedy Central show: Shorties Watchin' Shorties.

Virtual product placement uses computer graphics to insert the product into the program after the program is complete.

As of 2007, a new trend is emerging in product placement, the development of capabilities that permit dynamic or switchable product placement. Previously post production tools have permitted one time insertion of new product placement images and billboard advertising, e.g. at baseball or hockey games. As of 2007, new startups are offering or developing the ability to switch product placement. First generation virtual product placement has tended to be based upon sports arenas where the geometrical relationships of camera and the surface of the flat area onto which the billboard is projected, can be easily calculated. Second generation product placement or dynamic product placement is more focused upon commercial products. Third generation virtual or dynamic product placement allows targeting of customers with different products that can be dynamically switched based upon e.g. demographics, psychographics or behavioral information about the consumer. Also of interest are hypervideo techniques that can insert interactive elements into online video.

US 20060053048 discloses a method for improving upon the conventional pop-up ad, by introducing flexibility with regard to the shape of the advert and its placement in the surroundings of the web browser. Thus US 20060053048 addresses the shortcomings of standard rectangular adverts that often obscured the content they were presented in conjunction with. However, US 20060053048 discloses advert insertion that is not context dependent and does not present the possibility of dynamically controlling ads, as well as interacting with them.

US patent application 20030028873 discloses a method and system in which “labels,” comprising supplemental information such as advertising, promotional, or informational elements including interactive elements, may be superimposed post-production into a video stream. This is achieved by using overlay screens including interactive overlay screens or by combining video segments. As such, the labels do not have to physically be part of the actual scene during filming. Once a video stream is created, a space for available advertising is designated either manually or automatically by pattern recognition techniques. A list of available advertising space is generated. During viewing of television broadcasts, advertisements are placed in the video signal. Labels are displayed by superimposing an HTML page that is blank except for the advertisement onto the video signal. Advertisements can be superimposed post-production, and can be personalized and localized. The advertisements can be customized on a per-household basis.

However, while US patent application 20030028873 offers context dependent placement of ads in strategically identified predetermined locations along the timeline of the media, the ‘intelligent’ placement, and more particularly the context that triggers the insertion of the ad and its subsequent removal, is predetermined both in terms of the physical location and the duration of its appearance. Thus while US patent application 20030028873 offers contextual ad placement, it is limited to media with a single set timeline, such as a conventional prerecorded films. Presented with dynamic user dependent content, for example a video game or a live news feed, US patent application 20030028873 does not offer real-time context dependent means for controlling the timely insertion and removal of the overlay ad layer. Moreover, conventional means for visually identifying and tracking content, continually scan the content thereby placing substantial strain on computer processing power. Furthermore, the technology of choice for a ‘clickable’ overlay layer in US patent application 20030028873, namely HTML, severely limits its application. For example it prevents full screen presentation and is so cumbersome to execute in an interactive media, such as a video game, that it is virtually inapplicable. Moreover, US patent application 20030028873 does not provide efficient means and method for performing a heavy task of superimposing ads and removing them within the time frame of milliseconds. Moreover, by relying on HTML technology, in US patent application 20030028873 detecting user input may cause distortions to the view and to the user interface of the content. Furthermore, US patent application 20030028873 does not provide means and method for taking into account random or user defined themes in real time.

It is therefore a well felt need to provide an interactive media and more particularly a video game, ad placement means, that allows fort full screen playback of the video games. It is yet another long felt need to provide overlay layer ad placement means that overcomes the computer processing strain of continually scanning the content of and the content layer in order to determine the timely insertion and removal of said ads. Moreover, it is an especially long felt need in interactive media, wherein the timeline of the events of the content varies in accordance with input provider by the user. Furthermore, it is a well felt need to provide a method for tracking elements or objects within audio-visual content that does not require constant uninterrupted monitoring and analysis of the content stream. It is a further long felt need that the placement of the ads is not hampered by and does not interfere with the dynamic interactive nature of the gaming experience. It is a further long felt need that said ads are not limited to predetermined ‘electronic billboards’. It is a further long felt need that said ads do not interfere with the sequence of the game.

### SUMMARY OF THE INVENTION

It is an object of the present invention to disclose an ad placement system for superimposing advertising content onto video games, comprising: networked game playing means having access to at least one video game; object identification means having access to visual output of a plurality of game playing iterations of said at least one video game; means for obtaining real-time visual captions of visual output generated by said video game; object tracking means adapted for locating and tracking said identified objects; means for superimposing a stream of remotely stored advertising content onto said objects, in networked connection with said game playing means; emulation means that superimposes an invisible click, touch or event enabled emulation layer on top of said visual output from said video game; wherein said superimposed emulation layer communicates instructions to said game playing means, said means for superimposing ad content, or a combination thereof, such that insertion and removal of ad content corresponds to the dynamic real-time progression of said game, as well as real time user actions.

It is within the scope of the present invention that the format of said video caption is selected from a group consisting of bitmap image, binary file, text file, xml file, database object or any other means of holding the image data, or a combination thereof.

It is within the scope of the present invention that the format of said advertising content is selected from a group consisting of flash, animation, Html, script, images, video, hyperlink, music, vocals, or a combination thereof.

It is within the scope of the present invention that the physical characteristics of said advertising content is selected from a group consisting of transparent, semi-transparent, opaque, movement, rotation, or a combination thereof.

It is within the scope of the present invention that said advertising content is selected from a group consisting of vouchers, rebates, virtual prizes, physical prizes, or a combination thereof.

It is within the scope of the present invention that said ad placement system additionally comprising an audio processing and analysis means.

It is within the scope of the present invention that said game is compiled in a format selected from a group consisting of flash, video stream, java applet, C++ ActiveX, Adobe AIR Application, Widget, Gadget, Microsoft Silverlight, or a combination thereof.

It is within the scope of the present invention that said ad placement systemadditionally comprising software wrapper means adapted for communicating instructions to said remotely stored content streaming means.

It is within the scope of the present invention that said ad placement systemadditionally comprising a remote database for logging said instructions.

It is within the scope of the present invention that said ad placement system additionally comprising means for toggling between visible and invisible modes of said superimposed advertising content.

It is within the scope of the present invention that said ad placement system additionally comprising means for storing data obtained from said object identification means.

It is within the scope of the present invention that said ad placement system additionally comprising a real-time synchronization means for interrupting or canceling said stream of superimposed advertising content in response to data obtained from said object tracking means.

It is within the scope of the present invention that said ad placement system additionally comprising a display means interconnected to said playing means.

It is within the scope of the present invention that said object identification means is selected from a group consisting of a human observer, and automated observer, or a combination thereof.

It is within the scope of the present invention that said objects are selected from a group consisting of backgrounds, players, icons, items, script, images, videos, animation, or a combination thereof.

It is within the scope of the present invention that said networked connection is selected from a group consisting of wired, wireless, or a combination thereof.

It is within the scope of the present invention that said wireless communication means is selected from a group consisting of: WIFI, WIMAX, cellular, satellite, RFID, or a combination thereof.

It is within the scope of the present invention that said game playing means additionally comprises a GPS location identification means.

It is within the scope of the present invention that said game playing means additionally comprises a unique identification code.

It is within the scope of the present invention that said ad placement system additionally comprising image analyzing means for analyzing the visual characteristics of said objects and the area surrounding them.

It is within the scope of the present invention that said ad placement systemadditionally comprising object recognition processing means.

It is within the scope of the present invention that said emulation layer additionally comprises predefined trigger-zones wherein user input, video events, or a combination thereof trigger instructions to said ad superimposing means, said game playing means or a combination thereof.

It is within the scope of the present invention that said ad placement system additionally comprising event or user action activated sampling means.

It is yet another object of the present invention to disclose an ad placement method in video games, comprising the steps of obtaining an ad placement system for superimposing advertising content onto video games, comprising: networked game playing means having access to at least one video game; object identification means having access to visual output of a plurality of game playing iterations relating to said at least one video game; means for obtaining real-time visual captions, of visual output generated by said video game; object tracking means adapted for locating and tracking said identified objects; and, means for superimposing a stream of remotely stored advertising content onto said objects, in networked connection with said game playing means; emulation layer superimposing means that superimposes an invisible click, touch or game event enabled control layer on top of said visual output from said video game. identifying objects within said video game output by said object identification means; superimposing said invisible emulation layer onto said video game output; detecting, by means of said emulation layer, actions, events, or a combination thereof selected from a group comprising swipe, touch, multi-touch, click, mouse over, mouse up, mouse down, drag and drop, real time visual events or a combination thereof; capturing a real time video caption that corresponds to said actions, events, or combination thereof; searching said visual caption for said identified objects; locating said identified objects in said visual caption; superimposing said advertising content upon said identified objects in real-time bitmap frame; streaming said bitmap frame, superimposed with said ad to said game playing means; and repeating said searching and locating steps at intervals until said objects are located; wherein the sequence and location of said advertising content is determined by user actions or video game output events.

It is within the scope of the present invention that said capturing step comprises sampling a limited segment of the full video frame.

It is within the scope of the present invention that said limited segment is selected from a group consisting of: virtual buttons, virtual items, virtual objects, text, icons, animation, or a combination thereof.

It is within the scope of the present invention that additionally comprising a step of tracking said objects.

It is within the scope of the present invention that the instigation and duration of said tracking objects step is determined by user actions or video game events captured by said emulation layer.

It is within the scope of the present invention that said tracking step is executed by sampling a segment of the content video frame.

It is within the scope of the present invention that said ad placement method additionally comprising a step of interrupting said streaming step on object movement data obtained from said step of tracking said objects.

It is within the scope of the present invention that said interrupting step is selected from a group consisting of cancelling, fading out, shifting transparency rate, or a combination thereof.

It is within the scope of the present invention that said interrupting step is instigated by an additional step of interfacing with the user of said game playing means.

It is within the scope of the present invention that said interfacing step is selected from a group consisting of selecting game options, performing game actions, or a combination thereof.

It is within the scope of the present invention that said ad placement method additionally comprising a step of detecting, by means of said object tracking means, intervals in the progress, sequence or motion of said game, and subsequently superimposing said advertising content onto said identified objects.

It is within the scope of the present invention that said ad placement method additionally comprising wrapper means adapted for communicating instructions to said remotely stored content streaming means, said method comprising the additional step of downloading said wrapper to said game playing means, prior to having access to said plurality of video games.

It is within the scope of the present invention that said ad placement method additionally comprising a step of downloading said game to said networked game playing means.

It is within the scope of the present invention that said ad placement method additionally comprising object recognition processing means, said method additionally comprising a step of processing said video caption and retrieving object recognition data.

It is within the scope of the present invention that said ad placement method additionally comprising a step of selecting and contextually matching said selected advertisement content with said object recognition data.

It is within the scope of the present invention that said ad placement method additionally comprising a step of toggling between visible and invisible modes of said superimposed advertising content.

It is within the scope of the present invention that said ad placement method additionally comprising a step of masking said identified objects by means of superimposing said advertising content onto said identified object, such that said objects are no longer visible.

It is within the scope of the present invention that said ad placement method additionally comprising a step of interrupting or cancelling said stream of superimposed advertising content in response to data obtained from said object tracking means.

It is within the scope of the present invention that said ad placement method additionally comprising software wrapper means adapted for communicating instructions to said remotely stored content streaming means, said method additionally comprising

It is within the scope of the present invention that said ad placement method additionally comprising a remote database for logging said instructions, said method additionally comprising a step of logging said instructions.

It is within the scope of the present invention that said ad placement method additionally comprising an audio analysis means, said method additionally comprising a step of determining the sequence of superimposing said advertising content according to said analysis.

It is within the scope of the present invention that the display of said video game output and said superimposed layers is in fullscreen.

It is within the scope of the present invention that setting the frequency of said intervals is determined in a manner selected from a group consisting of: predetermined, determined by user input or video game events captured by said emulation layer, or a combination thereof. It is within the scope of the present invention that said capturing and searching steps are triggered by user actions detected upon said emulation layer, thereby minimizing the time that strain is placed upon computer processing power.

### BRIEF DESCRIPTION OF THE FIGURES

In order to better understand the invention and its implementation in practice, a plurality of embodiments will now be described, by way of non-limiting example only, with reference to the accompanying drawings, in which

FIG. 1 illustrates a schematic view of a preferred embodiment of the ad placement method in video games of the present invention, wherein a processing means, having access to a screen caption of said a real-time game image, locates and tracks the appearance of previously identified script object ‘GET READY’, said processing means instructing remote advertising content stream provider to stream superimposed advertising content onto said real-time game image until said processing means detects that said script object is no longer visible and cancels said superimposed content.

FIG. 2 illustrates a schematic view of a preferred embodiment of the ad placement method in video games of the present invention, wherein a processing means, having access to a screen caption of said a real-time game image, locates and tracks the appearance of previously identified script object ‘GET READY’, said processing means instructing remote advertising content stream provider to stream superimposed advertising content onto said real-time game image until said processing means detects that said script object is no longer visible, and thereon cancel said stream and superimpose Coca Cola™ product placement advertisement content upon predetermined identified object positions.

### DETAILED DESCRIPTION OF THE PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide means and method for product placement in video games.

The system of the present invention has many technological advantages, among them: Reducing antagonism towards advert funded websites; Reducing errors due to incompatibilities with specific web-browsers and web technologies; Facilitating control over physical attributes of web adverts; and Facilitating filtering of the content of web adverts. Additional features and advantages of the invention will become apparent from the following drawings and description.

The term ‘masks’ or ‘masking’ interchangeably refers hereinafter to superimposing a first graphical object with a second graphical object, such that said first is no longer visible.

The term ‘Push advertising’ refers hereinafter to all efforts to get the word out to an entire group of potential customers in order to hit the few that many be currently interested in your product or service. Most traditional offline advertising efforts (magazine, billboard, newspaper, tv, classifieds, etc) as well as online banners ads and email broadcasts are considered push marketing.

The term ‘Product Placement’ refers hereinafter to a type of advertising, in which promotional advertisements placed by marketers using real commercial products and services in media, where the presence of a particular brand is the result of an economic exchange. When featuring a product is not part of an economic exchange, it is called a product plug. Product placement appears in plays, film, television series, music videos, video games and books. It became more common starting in the 1980s, but can be traced back to at least 1949. Product placement occurs with the inclusion of a brand's logo in shot, or a favorable mention or appearance of a product in shot. This is done without disclosure, and under the premise that it is a natural part of the work. Most major movie releases today contain product placements. The most common form is movie and television placements and more recently computer and video games. Recently, websites have experimented with in-site product placement as a revenue model.

The term ‘overlay’ refers hereinafter to superimposing an overlay layer upon a video content layer thereby creating a visual impression, by means of a synchronized photomontage effect, that objects within the overlay layer are integrated in the content layer. Moreover, the overlay layer may mask objects within the content layer thereby enabling product placement superimposed upon a content layer.

The term ‘object tracking’ is the critical task in many computer vision applications such as surveillance, perceptual user interfaces, augmented reality, smart rooms, object-based video compression, and driver assistance.

The term ‘Augmented reality (AR)’ is a field of computer research which deals with the combination of real-world and computer-generated data. At present, most AR research is concerned with the use of live video imagery which is digitally processed and “augmented” by the addition of computer-generated graphics. Advanced research includes the use of motion-tracking data, fiducial marker recognition using machine vision, and the construction of controlled environments containing any number of sensors and actuators.

The term ‘Publisher’ refers hereinafter to a body that has means for streaming dynamic content. Examples of current web based publishers are: Channel.TV, Youtube.com, and Bebo.com. The format of published content may consist of video on demand (VOD), live event, user generated content (UGC), broadcasting live channels, or a combination thereof.

The term ‘video content owner’ refers hereinafter to the legal owner of video content be said content self produced and owned by a private individual, or commercially produced and owned by means of assigning rights.

The term ‘Advertiser’ refers hereinafter to any legally accountable body that wishes to advertise itself in conjunction with playing of web based video content. An advertiser may be an advert agency, a branding company and ad junction or a combination thereof.

The term ‘Advert’ refers hereinafter to traditional adverts or branding adverts, either in conventional web advert advert form selected from a group consisting of: banners, text links, and flash, or by advanced product placement enabled by visually analyzing the content, tagging it and overlaying it with product placement.

The term ‘Creative Community’ refers hereinafter to artists skilled in creating images for populating an overlay layer.

The term ‘Online Overlay Generation’ refers hereinafter to a self-service automated overlay generation system that automates the generation of objects including images, banners, text and links to be incorporated within an overlay layer. Said objects may be utilized to mask or swap objects within the content layer. For example a commercial bottle, or the label thereof, may be superimposed onto a similar object in the content layer.

The term ‘placement zone’ refers to a space, void or surface in at least one frame of a content video that may be superimposed by an element contained within an overlay layer, said element selected from a group consisting of: a logo, a brand, an image, a product image, a moto, a text, a link, or a combination thereof.

The term ‘superimposed data’ (SID), refers hereinafter to members selected from a group consisting of: still images, films, augmented reality, illustrations, highlights, script, animation, hologram, hyperlink, or a combination thereof.

The term ‘bitmap’ or ‘pixmap’ refers hereinafter to a spatially mapped array of pixels.

The term ‘bitmap time synchronizing’ refers to a method for synchronizing an overlay layer with a content layer, wherein the overlay layer and the content layer are streamed to the viewer's computing means. Both streams remain suspend while the overlay layer is split into an array of bitmap frames. The video is then played and once a predetermined frame of the content layer is reached said bitmap frames are superimposed upon said content layer. For example if the overlay layer contains an object that is to be display from timeline 60 sec to timeline 65 sec, on a video running at 25 frames per second, then the split overlay layer will contain 625 bitmap frames to be superimposed onto the overlay layer.

The term ‘cue point event synchronization’ refers to a method for synchronizing an overlay layer with a content layer, wherein the overlay layer and the content layer are streamed to the viewer's computing means. Both streams remain suspend while the overlay layer is split into an array of bitmap frames. The video is then played and once a predetermined time has elapsed of the content layer is reached said bitmap frames are superimposed upon said content layer.

The term ‘sync monitor’ refers hereinafter to a means for monitoring video player events selected from a group consisting of: buffering, stopping play, pausing play or a combination thereof, and matching the sequence of overplayed bitmap frames to said events.

The term ‘live feed’ refers hereinafter to a video stream of a live event such as a football game.

The term ‘recorded feed’ refers hereinafter to a video stream of a previously recorded video.

The term ‘object’ refers hereinafter to any visual depiction of actual objects, backgrounds, voids or spaces, contained within a video, or a combination thereof.

The term ‘data ticker’ refers hereinafter to information services that provide information to Web Pages or to any electronic device with broadcasting capabilities by wireless or Web based feeds.

The term ‘RSS’ refers hereinafter to a family of Web feed formats used to publish frequently updated content such as blog entries, news headlines; and podcasts in a standardized format.

The term ‘emulation layer’ refers hereinafter to mirror the layout of the video game output, or parts thereof, such that actions performed by the user via conventional user interface, or events in the progression of the video game, may be monitored or captured. Monitoring or capturing is either performed continually, or in intervals determined by data retrieved from human or automatic pre-analysis of the scenarios of the game output.

The term ‘embedded’ refers hereinafter to the action of integration, such that the element being embedded is united with element it is being integrated in, such that the two become one. For example, once an image is embedded in a background image, they become united into one image. By contrast, in the action of layering images or superimposing them, each layer remains independent.

The term ‘stream’ refers hereinafter to a method of broadcasting media to a viewer from a distant point, the means of broadcasting may include radio wave broadcasting, web based broadcast, satellite broadcast, landline broadcast, cable broadcast, or a combination thereof.

The term ‘Wrapper’ refers hereinafter to software that accompanies resources or other software for the purposes of improving convenience, compatibility, or security. For example, a wrapper is used to compress and encrypt software that is being sold over the Internet.

The term ‘video game’ refers hereinafter to electronic games having visual characteristics selected from a group consisting of online games, downloaded games, multiple player games, peer games, network based games, remote server based games, locally based games, game streams, or a combination thereof.

The term ‘Multi-Touch’ refers hereinafter to a set of interaction techniques which allow computer users to control graphical applications with several fingers. Multi-touch consists of a touch screen (screen, table, wall, etc.) or touchpad, as well as software that recognizes multiple simultaneous touch points, as opposed to the standard touchscreen (e.g. computer touchpad, ATM), which recognizes only one touch point. This effect is achieved through a variety of means, including but not limited to: heat, finger pressure, high capture rate cameras, infrared light, optic capture, tuned electromagnetic induction, ultrasonic receivers, transducer microphones, laser rangefinders, and shadow capture.

The term ‘sampling’ refers hereinafter to periodically capturing a visual segment of the fullscreen video content and subsequently analyzing visual aspects of said segment.

The present invention is especially useful for intelligently inserting ads into the correct slot of dynamic content, such as video games, without placing strain on processing power. For example consider a game wherein certain virtual buttons or controls appear on particular levels of the game, but not on others. Traditional object tracking means an method would require continuous tracking of the segment of video content in order to detect the appearance of said buttons or controls, and subsequently activate a means for registering input from the user, such as a mouse click. Due to the continuos video capture and analysis involved in this conventional process, a significant strain is placed on processing power. The present invention provides an alternative method to detecting the appearance of a virtual button or control. Rather than continuously capturing a segment of the video, the present invention monitors the mouse actions by detecting a click upon an emulation layer superimposed upon the content. Only once the click is detected is the sampling of the content triggered and subsequently the progression of the game is determined. Thus by removing the need to continuously track objects within the content layer, processing power requirements are reduced.

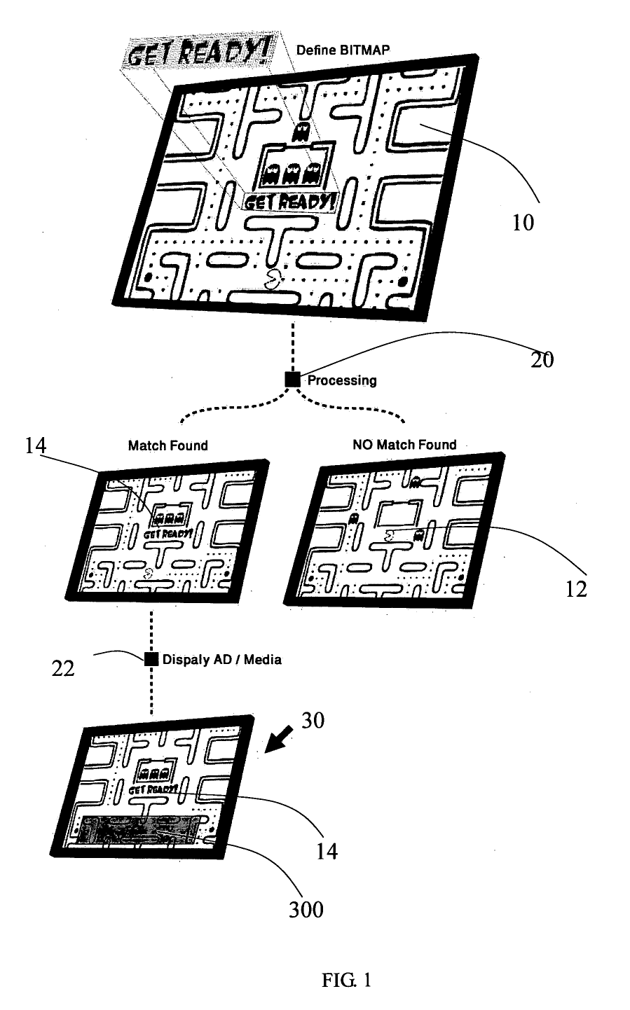

Reference is now made to FIG. 1, illustrating a schematic view of a preferred embodiment of the ad placement method in video games of the present invention, wherein real-time image 10 is presented to the player on a game playing means, a processing means 20, having access to a screen caption of said real-time image, locates and tracks the appearance of previously identified script object 14 ‘GET READY’, said processing means is networked (not shown) with remote advertising content stream provider 22, instructing said provider to stream superimposed advertising content 300 onto image 10, thus displaying image 30 until said processing means detects that said script object is no longer visible and cancels said superimposed content thereby reverting to image 10.

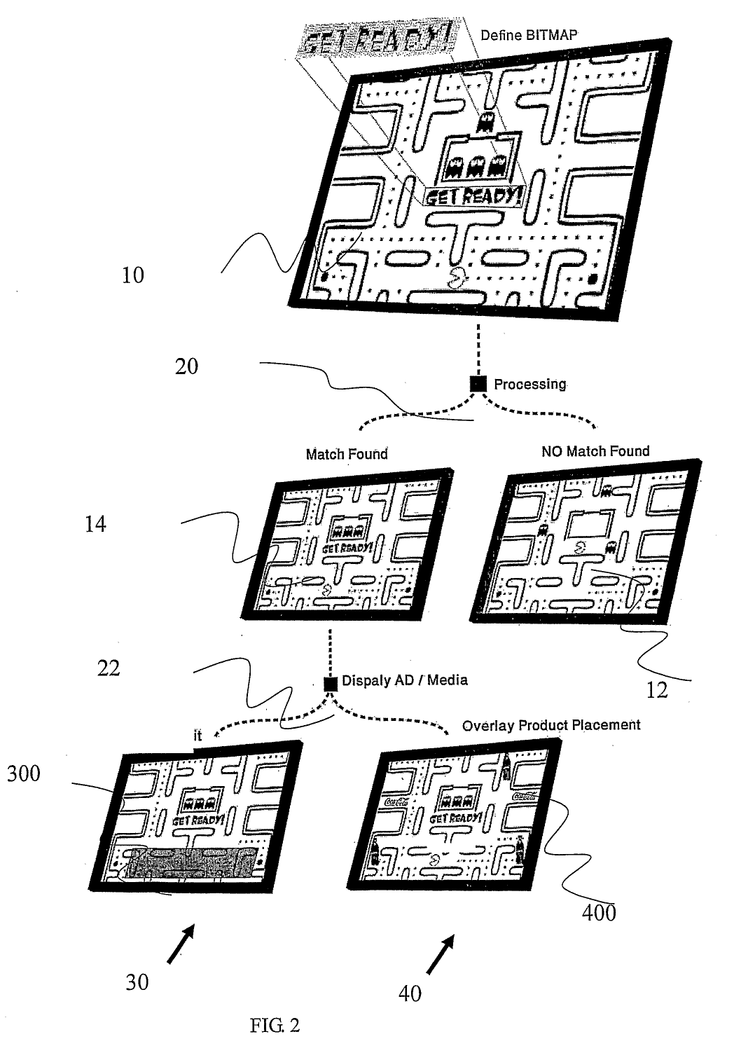

Reference is now made to FIG. 2, illustrating a schematic view of a preferred embodiment of the ad placement method in video games of the present invention, wherein real-time image 10 is presented to the player on a game playing means, a processing means 20, having access to a screen caption of said real-time image, locates and tracks the appearance of previously identified script object 14 ‘GET READY’, said processing means is networked (not shown) with remote advertising content stream provider 22, instructing said provider to stream superimposed advertising content 300 onto image 10, until said processing means detects that said script object is no longer visible, and thereon cancel said stream and superimposed Coca Cola™ product placement advertisement content 400 upon predetermined identified object positions.

1-47. (canceled)

48. An ad placement system for superimposing advertising content onto video games, comprising:
a. networked game playing means having access to at least one video game;
b. object identification means having access to visual output of a plurality of game playing iterations of said at least one video game;
c. means for obtaining real-time visual captions of visual output generated by said video game;
d. object tracking means adapted for locating and tracking said identified objects;
e. means for superimposing a stream of remotely stored advertising content onto said objects, in networked connection with said game playing means;
f. emulation means that superimposes an invisible, click, touch or event enabled emulation layer on top of said visual output from said video game;
wherein said superimposed emulation layer communicates instructions to said game playing means, said means for superimposing ad content, or a combination thereof, such that insertion and removal of ad content corresponds to the dynamic real-time progression of said game, as well as real time user actions.

49. The system according to claim 48, wherein the format of said video caption is selected from a group consisting of bitmap image, binary file, text file, xml file, database object or any other means of holding the image data, or a combination thereof.

50. The system according to claim 48, wherein the format of said advertising content is selected from a group consisting of flash, animation, Html, script, images, video, hyperlink, music, vocals, or a combination thereof.

51. The system according to claim 48, wherein the physical characteristics of said advertising content is selected from a group consisting of transparent, semi-transparent, opaque, movement, rotation, or a combination thereof.

52. The system according to claim 48, wherein said advertising content is selected from a group consisting of vouchers, rebates, virtual prizes, physical prizes, or a combination thereof.

53. The system according to claim 48, additionally comprising an audio processing and analysis means.

54. The system according to claim 48, wherein said game is compiled in a format selected from a group consisting of flash, video stream, java applet, C++ ActiveX, Adobe AIR Application, Widget, Gadget, Microsoft Silverlight, or a combination thereof.

55. The system according to claim 48, additionally comprising software wrapper means adapted for communicating instructions to said remotely stored content streaming means.

56. The system according to claim 48, additionally comprising a remote database for logging said instructions.

57. The system according to claim 48, additionally comprising means for toggling between visible and invisible modes of said superimposed advertising content.

58. The system according to claim 48, additionally comprising means for storing data obtained from said object identification means.

59. The system according to claim 58, additionally comprising a real-time synchronization means for interrupting or canceling said stream of superimposed advertising content in response to data obtained from said object tracking means.

60. The system according to claim 48, additionally comprising a display means interconnected to said playing means.

61. The system according to claim 48, wherein said object identification means is selected from a group consisting of a human observer, and automated observer, or a combination thereof.

62. The system according to claim 48, wherein said objects are selected from a group consisting of backgrounds, players, icons, items, script, images, videos, animation, or a combination thereof.

63. The system according to claim 48, wherein said networked connection is selected from a group consisting of wired, wireless, or a combination thereof.

64. The system according to claim 63, wherein said wireless communication means is selected from a group consisting of: WIFI, WIMAX, cellular, satellite, RFID, or a combination thereof.

65. The system according to claim 48, wherein said game playing means additionally comprises a GPS location identification means.

66. The system according to claim 48, wherein said game playing means additionally comprises a unique identification code.

67. The system according to claim 48, additionally comprising image analyzing means for analyzing the visual characteristics of said objects and the area surrounding them.

68. The system according to claim 48, additionally comprising object recognition processing means.

69. The system according to claim 48, wherein said emulation layer additionally comprises predefined trigger-zones wherein user input, video events, or a combination thereof trigger instructions to said ad superimposing means, said game playing means or a combination thereof.

70. The system according to claim 48, additionally comprising event or user action activated sampling means.

71. An ad placement method in video games, comprising the steps of
a. obtaining an ad placement system for superimposing advertising content onto video games, comprising:
i. networked game playing means having access to at least one video game;
ii. object identification means having access to visual output of a plurality of game playing iterations relating to said at least one video game;
iii. means for obtaining real-time visual captions, of visual output generated by said video game;
iv. object tracking means adapted for locating and tracking said identified objects; and,
v. means for superimposing a stream of remotely stored advertising content onto said objects, in networked connection with said game playing means;
vi. emulation layer superimposing means that superimposes an invisible click, touch or game event enabled control layer on top of said visual output from said video game.
b. identifying objects within said video game output by said object identification means;
c. superimposing said invisible emulation layer onto said video game output;detecting, by means of said emulation layer, actions, events, or a combination thereof selected from a group comprising swipe, touch, multi-touch, click, mouse over, mouse up, mouse down, drag and drop, real time visual events or a combination thereof;
d. capturing a real time video caption that corresponds to said actions, events, or combination thereof;
e. searching said visual caption for said identified objects;
f. locating said identified objects in said visual caption;
g. superimposing said advertising content upon said identified objects in real-time bitmap frame;
h. streaming said bitmap frame, superimposed with said ad to said game playing means; and
i. repeating said searching and locating steps at intervals until said objects are located;
wherein the sequence and location of said advertising content is determined by user actions or video game output events.

72. The method according to claim 71, wherein said capturing step comprises sampling a limited segment of the full video frame.

73. The method according to claim 72, wherein said limited segment is selected from a group consisting of: virtual buttons, virtual items, virtual objects, text, icons, animation, or a combination thereof.

74. The method according to claim 71, additionally comprising a step of tracking said objects.

75. The method according to claim 74, wherein the instigation and duration of said tracking objects step is determined by user actions or video game events captured by said emulation layer.

76. The method according to claim 74, wherein said tracking step is executed by sampling a segment of the content video frame.

77. The method according to claim 71, additionally comprising a step of interrupting said streaming step on object movement data obtained from said step of tracking said objects.

78. The method according to claim 77, wherein said interrupting step is selected from a group consisting of cancelling, fading out, shifting transparency rate, or a combination thereof.

79. The method according to claim 77, wherein said interrupting step is instigated by an additional step of interfacing with the user of said game playing means.

80. The method according to claim 71, wherein said interfacing step is selected from a group consisting of selecting game options, performing game actions, or a combination thereof.

81. The method according to claim 71, additionally comprising a step of detecting, by means of said object tracking means, intervals in the progress, sequence or motion of said game, and subsequently superimposing said advertising content onto said identified objects.

82. The method according to claim 71, additionally comprising wrapper means adapted for communicating instructions to said remotely stored content streaming means, said method comprising the additional step of downloading said wrapper to said game playing means, prior to having access to said plurality of video games.

83. The method according to claim 71, additionally comprising a step of downloading said game to said networked game playing means.

84. The method according to claim 71, additionally comprising object recognition processing means, said method additionally comprising a step of processing said video caption and retrieving object recognition data.

85. The method according to claim 71, additionally comprising a step of selecting and contextually matching said selected advertisement content with said object recognition data.

86. The method according to claim 71, additionally comprising a step of toggling between visible and invisible modes of said superimposed advertising content.

87. The method according to claim 71, additionally comprising a step of masking said identified objects by means of superimposing said advertising content onto said identified object, such that said objects are no longer visible.

88. The method according to claim 71, additionally comprising a step of interrupting or cancelling said stream of superimposed advertising content in response to data obtained from said object tracking means.

89. The method according to claim 71, additionally comprising software wrapper means adapted for communicating instructions to said remotely stored content streaming means, said method additionally comprising.

90. The method according to claim 89, additionally comprising a remote database for logging said instructions, said method additionally comprising a step of logging said instructions.

91. The method according to claim 71, additionally comprising an audio analysis means, said method additionally comprising a step of determining the sequence of superimposing said advertising content according to said analysis.

92. The method according to claim 71, wherein the display of said video game output and said superimposed layers is in fullscreen.

93. The method according to claim 71, wherein setting the frequency of said intervals is determined in a manner selected from a group consisting of: predetermined, determined by user input or video game events captured by said emulation layer, or a combination thereof.

94. The method according to claim 71, wherein said capturing and searching steps are triggered by user actions detected upon said emulation layer, thereby minimizing the time that strain is placed upon computer processing power.
